(19) United States
(12) Patent Application Publication
(10) Pub. No.: US 2007/0017263 A1
(43) Pub. Date: Jan. 25, 2007

(54) Cylinder support tool

(75) Inventor: Grant Shafer, Oak Park, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 11/187,952

(22) Filed: Jul. 25, 2005

(51) Int. Cl. E05B 15/16; E05B 63/00

(52) U.S. Cl. 70/18

(57) ABSTRACT

An apparatus and method for supporting a cylinder is provided. The cylinder support tool includes a first and second-half cylinders each having collars at each end. A locking assembly is provided to lock the first and second-half cylinders together. The cylinder support tool can be positioned around a hydraulic system that includes a cylinder and piston in order to keep the cylinder in a desired position. The cylinder support tool provides a mechanical means to keep the cylinder in the desired position should the hydraulic pressure fails.

### FIELD OF THE INVENTION

The present invention relates generally to an apparatus and method for supporting a cylinder in a vehicle. More particularly, the present invention relates to an apparatus and method for supporting a cylinder in a particular position in the vehicle.

### BACKGROUND OF THE INVENTION

Vehicles such as dump or garbage trucks typically have a hydraulic/pneumatic piston and cylinder assembly for raising and lowering the bed of the dump truck or for picking up and lowering dumpsters by the garbage truck. After multiple use, the piston and cylinder or the bed of the dump truck will need servicing and may require the cylinder or the bed to be in a locked position. An operator can set the cylinder to the desired locked position for servicing, but the cylinder can become unlocked on its own due to a loss in hydraulic pressure and cause injury to operator during servicing.

As a safety precaution, service personnel use cylinder locking devices to manually lock the cylinder in place. However, these locking devices are two U-shaped pieces that are connected together by locking pins. The U-shaped half pieces are typically only one size and require many holes for locking pins to pass through in order to make the locking device fit better with the cylinder. Unfortunately, even with many locking holes, there can still be too much “play” between the locking device and the cylinder due to its U-shape, further making it unsafe for the operator. Additionally, the locking pins are typically not attached to the locking device and can become lost with repeated use.

Accordingly, it is desirable to provide a locking device that better fits around the cylinder for added safety. Also, it is desirable to have the locking pin connected with the cylinder lock so that it is not easily lost.

### SUMMARY OF THE INVENTION

The foregoing needs are met, to a great extent, by the present invention, wherein in one aspect an apparatus is provided that in some embodiments a cylinder support tool that can be positioned to mate with a cylinder.

In accordance with one embodiment of the present invention, a cylinder support device is provided and can include a first half-cylinder having a first collar at a first end, a second collar at a second end and a first handle, a second half-cylinder having a third collar at a first end, a fourth collar at second end and a second handle, and a lock assembly having a wire that can be coupled to a pin, the lock assembly that can lock the first half-cylinder and the second half-cylinder around the cylinder via the pin, wherein the first and second half-cylinders may be pivotally connected to each other.

In accordance with another embodiment of the present invention, a method of holding a cylinder in a position is provided and can include placing a cylinder support device around the cylinder, the cylinder support device having a first half-cylinder with a first collar at a first end and a second collar at a second end and a second half-cylinder with a third collar at a first end and a fourth collar at a second end, wherein the first and second-half cylinders can be pivotally connected to each other, moving a first handle on the first half-cylinder and a second handle on the second half-cylinder so that the first half-cylinder and second half-cylinder close around the cylinder, and locking the cylinder support device with a lock assembly having a wire that can be coupled to a pin that can be received in a portion of the first half-cylinder and the second half-cylinder.

In accordance with yet still another embodiment of the present invention, a system for supporting a cylinder is provided and can include first means for supporting having a first collar at a first end, a second collar at a second end and a first handle means, second means for supporting have a third collar at a first end, a fourth collar at second end and a second handle means, and means for locking having a pulling means coupled to a wire that may be coupled to a pin, the means for locking locks the first and second means for supporting around the cylinder, wherein first and second means for supporting may be pivotally connected to each other.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a cylinder support tool in a closed position according to a preferred embodiment of the invention.

FIG. 2 illustrates a pin assembly of a lock assembly.

FIG. 3 illustrates the cylinder support tool in a locked position around the cylinder of the piston.

FIG. 4 illustrates the cylinder support tool in the open position.

### DETAILED DESCRIPTION

The invention will now be described with reference to the drawing figures, in which like reference numerals refer to like parts throughout. The present invention provides for a cylinder support tool and method of use to manually support a cylinder in a particular position.

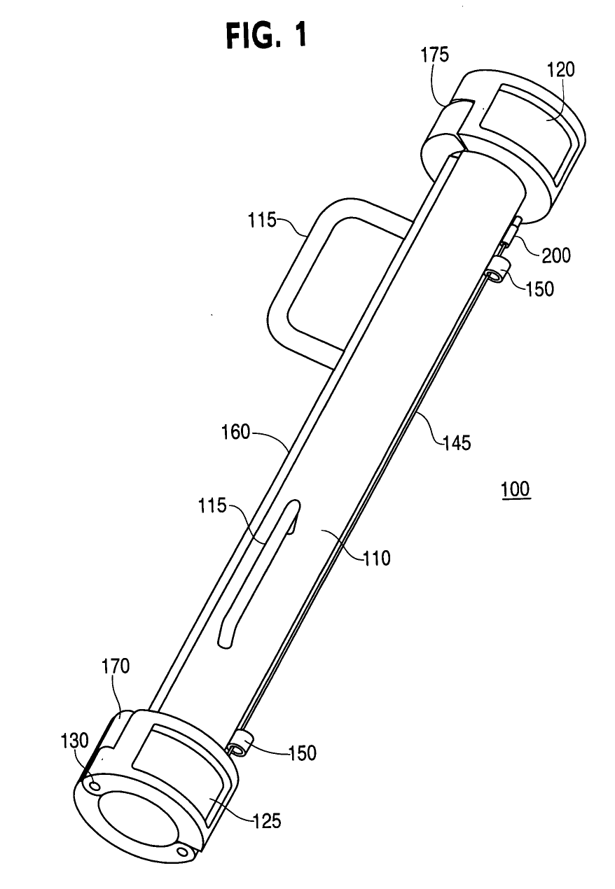

An embodiment of the present inventive apparatus is illustrated in FIG. 1, which is a perspective view of the cylinder support tool 100 in a closed position. The cylinder support tool 100 includes a first half-cylinder 110 and second half-cylinder 160 and a lock assembly. The first half-cylinder 110 includes a first collar 120 at a first end, a second collar 125 at a second end and a handle 115. The second half-cylinder 160 includes a first collar 175 at a first end, a second collar 170 at a second end and a handle 115. The first half-cylinder 110 and second half-cylinder 160 can be complementary to each other so that when positioned together they can form a full cylinder of the cylinder support tool 100. The inner diameter of the cylinder support tool 100 can be constructed and designed to fit around any cylinder of a piston by constructing half-cylinders of varying sizes.

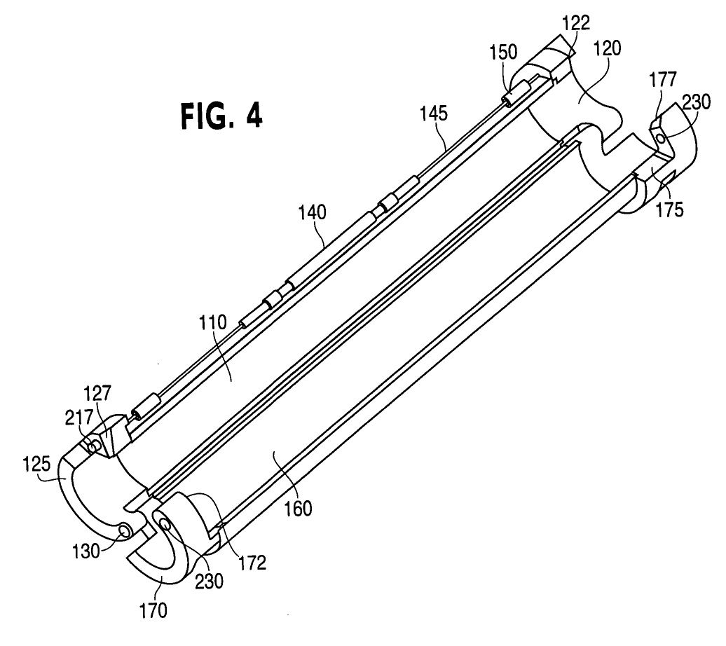

The first half-cylinder 110 and the second half-cylinder 160 can be hinged together by pins 130 that pass through a portion of the first collars 120, 175 and second collars 125, 170 at the first and second ends. The pins 130 allow the first half-cylinder 110 and second half-cylinder 160 to pivot in open and closed positions (see FIG. 4 for open position). The handles 115 can be used by the operator to move the respective half-cylinders 110, 160 to an open and a closed position.

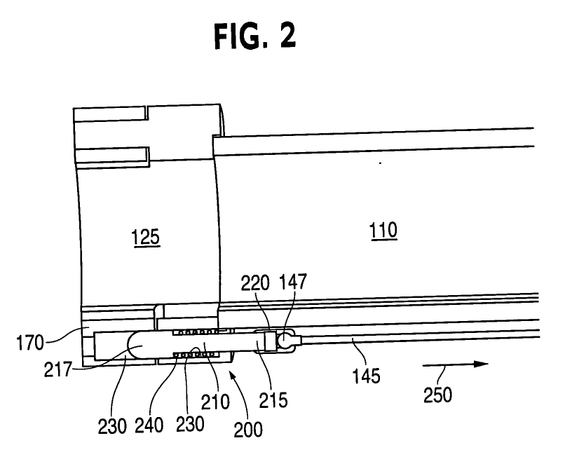

FIG. 1 also illustrates the components of a locking assembly, such as a wire 145, retaining rings 150, and the pin assembly 200. The pin assembly 200 is further illustrated in FIG. 2. The wire 145 can be any wire material, such as steel, copper, zinc, aluminum or another other wire material that can use with the pin assembly. The retaining rings 150 receive the wire 145 and assist in retaining the wire 145 against the first half-cylinder so that the wire does not interfere with the use of the cylinder support tool 100. The retaining rings 150, although shown at different ends of the first half-cylinder 110, can be positioned anywhere along the first half-cylinder. Additionally, a person skilled in the art would recognize that the locking assembly can be located on either the first or the second half cylinders 110, 160 and is not limited to either one. The locking assembly allows the operator to lock the cylinder support tool 100 in a locked (closed) position when the operator desires to retain the cylinder of the piston in a certain position. The locking assembly also allows the operator to unlock (open) the cylinder support tool 100 in order to remove it from the cylinder of the piston after use. The operation of the locking assembly will be further discussed below.

In an alternative embodiment, the wire further includes a puller handle. The puller handle can be made from any material such as a metal, plastic, composite material or any material that allows the operator to grip the handle. The puller handle makes it easier for the operator to pull on the wire.

FIG. 2 illustrates the pin assembly 200 of the locking assembly. A portion of the first half-cylinder 110 is shown having the pin assembly 200 at an end. The pin assembly 200 can lock and unlock the first and second half-cylinders 110, 160 via the first collars 120, 175 and second collars 125, 170. The wire 145 includes at each of its end a bulb portion 147 that can be received in a clip 220. The clip 220 also receives and couples with a first end 215 of a pin 210. The clip 220 can be coupled with the first end 215 of pin 210 via various known methods such as welding, gluing, or any other coupling means so that the two pieces can be coupled together. The pin 210 is also received in a chamber 230 that is present on both second collars 125, 170. The chamber 230 allows axial movement of the pin when it is actuated by the wire being pulled. The pin 210 also includes a second end 217 that is constructed and designed to prevent the second collars 125, 170 of the respective half-cylinders from disengaging each other when the cylinder support tool is in the locked position. A spring 240 biases the pin 210 in an extended position so that when the chamber 230 of the respective collars are aligned, the pin 210 will be biased into the extended position to lock the half-cylinders. A person skilled in the art will recognize that this pin assembly 200 and the locking assembly also work with second collars 125, 170 and that FIG. 2 is applicable to the other end of the first and second half-cylinders 110, 160.

In operation, to unlock the half-cylinders 110, 160, the operator pulls on the wire in a first direction causing the wire 145 to pull on the clip 220, which further causes the pin 210 to move axially, for example, in a direction of arrow 250. The operator pulls the wire 145 so that the second end 217 of the pin 210 releases the first collar 170 from first collar 125 and the second collar 175 from second collar 120. The release can be simultaneous or only one set of the collars open at a time. However, by releasing simultaneously, the operator can unlock both sets of the collars at the same time, thereby saving time and decrease the chance of injury or error. FIG. 1 illustrates the locking device in the unlock position.

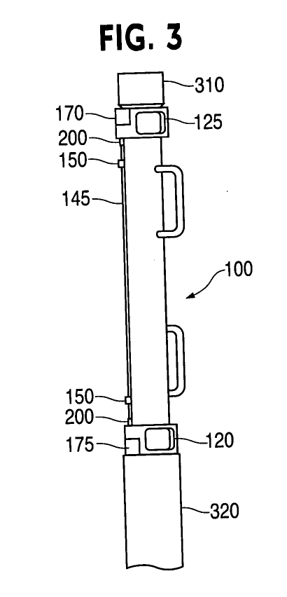

To lock the half-cylinders 110, 160, the operator can position the half-cylinders over the cylinder of the piston and use the handles to bring the half-cylinders together (see FIG. 3). The first and second collars 120, 175, 125, 170 have camming surfaces 122, 177, 127, 172 (see FIG. 4) so that when said surfaces interact with pin 217, it will ride up the top surface of the pin 217 and depress the pin in a compressed position. Once the chambers 230 of the first and second collars 120, 175, 125, 170 are aligned, the pin 217 decompresses and can be positioned in both chambers 230 of the first and second collars to lock the cylinder support tool 100. Alternatively, the operator pulls the wire 145, which compresses the pin 217, then closes the half-cylinders 110, 160 together and finally releases the wire thereby decompressing the pin.

FIG. 3 illustrates the cylinder support tool 100 in the locked position around the cylinder 310 of piston 320. As shown, first collars 120, 175 and second collars 125 170 are locked in the closed position around a cylinder 310. By being in the closed position around a bottom portion of the cylinder 310, the cylinder support tool 100 prevents the cylinder 310 from returning to a piston 320, thus allowing the operator to service the vehicle safely. Therefore, even if the cylinder was locked in place through the vehicle's own locking mechanism, with the locking device 100 in place around the cylinder, the cylinder will be held in that locked position even if the vehicle's locking mechanism fails due to hydraulic pressure loss.

FIG. 4 illustrates the cylinder support tool 100 in the open position. The first half-cylinder 110 includes along its outer surface the wire 145, the retaining rings 150, which are components of the locking assembly. Additionally, the first half-cylinder 110 includes the first and second collars 120, 125 with their respective camming surfaces 122, 127, chambers 130, and pins 217. The second half-cylinder 160 includes the first and second collars 175, 170, which includes the chambers 130 and the camming surfaces 177, 172. The first and second half-cylinders are pivotally connected by pins 130. Also shown, in the alternative embodiment, is puller handle 140 that surrounds the wire 145. The puller handle 140 allows the user a means to better pull the wire 145.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A cylinder support device, comprising:
a first half-cylinder having a first collar at a first end, a second collar at a second end and a first handle;
a second half-cylinder having a third collar at a first end, a fourth collar at second end and a second handle; and
a lock assembly having a wire that is coupled to a pin, the lock assembly locks the first half-cylinder and the second half-cylinder around the cylinder via the pin, wherein the first and second half-cylinders are pivotally connected to each other.

2. The cylinder support device of claim 1, wherein the pin is biased by a spring and the pin is received in a chamber.

3. The cylinder support device of claim 1, wherein the third collar and fourth collar of the second half-cylinder have camming surfaces to mate with the pin.

4. The cylinder support device of claim 1, wherein the lock assembly is located on the first half-cylinder and further includes at least one retaining ring that receives the wire and a puller handle located on a portion of the wire.

5. The cylinder support device of claim 1, wherein the lock assembly is an automatic lock assembly.

6. The cylinder support device of claim 1, wherein an operator can unlock the cylinder support device by pulling on any portion of the wire.

7. The cylinder support device of claim 1, wherein an operator can lock the cylinder support device by pulling on any portion of the wire.

8. The cylinder support device of claim 1, wherein the first collar and second collar have camming surfaces to mate with the pin.

9. A method of holding a cylinder in a position, comprising:
placing a cylinder support device around the cylinder, the cylinder support device having a first half-cylinder with a first collar at a first end and a second collar at a second end and a second half-cylinder with a third collar at a first end and a fourth collar at a second end, wherein the first and second-half cylinders are pivotally connected to each other;
moving a first handle on the first half-cylinder and a second handle on the second half-cylinder so that the first half-cylinder and second half-cylinder close around the cylinder; and
locking the cylinder support device with a lock assembly having a wire that is coupled to a pin that can be received in a portion of the first half-cylinder and the second half-cylinder.

10. The method of claim 9, wherein locking the cylinder support device further comprises sliding a camming surface on third collar and fourth collar across a surface of the pin.

11. The method of claim 9, wherein the locking the cylinder support device further comprises pulling on the wire to cause the pin to move in first direction and releasing the puller handle to cause the pin to move in a second direction.

12. The method of claim 9 further comprising unlocking the cylinder support device by pulling on the wire.

13. A system for supporting a cylinder, comprising:
first means for supporting having a first collar at a first end, a second collar at a second end and a first handle means;
second means for supporting have a third collar at a first end, a fourth collar at second end and a second handle means; and
means for locking having a pulling means coupled to a wire that is coupled to a pin, the means for locking locks the first and second means for supporting around the cylinder, wherein first and second means for supporting are pivotally connected to each other.

14. The system for supporting of claim 13, wherein the means for locking further includes the pin being biased by a biasing means and received in a chamber.

15. The system for supporting of claim 13, wherein the first and second means for supporting have camming surfaces to mate with the pin.

16. The system for supporting of claim 13, wherein the means for locking is located on the first means for supporting and further includes at least one means for retaining that receives the wire and a puller handle located on a portion of the wire.

17. The system for supporting of claim 13, wherein the means for locking is an automatic means for locking.

18. The system for supporting of claim 13, wherein an operator can unlock the system for supporting a cylinder by pulling on any portion of the wire.

19. The system for supporting of claim 13, wherein an operator can lock the system for supporting the cylinder by pulling on any portion of the wire.

20. The system for supporting of claim 13, wherein the first, second, third and fourth collars have camming surfaces to mate with the pin.
